(19) United States
(12) Patent Application Publication
(10) Pub. No.: US 2010/0110137 A1
(43) Pub. Date: May 6, 2010

(54) USE OF VCSEL TO DETECT PAPER IN A PRINTER

(75) Inventor: Jimmy Alan Tatum, Plano, TX (US)

Correspondence Address: Workman Nydegger;1000 Eagle Gate Tower, 60 East South Temple, Salt Lake City, UT, 84111, US

(73) Assignee: FINISAR CORPORATION, Sunnyvale, CA (US)

(21) Appl. No.: 12/610,694

(22) Filed: Nov. 2, 2009

Related U.S. Application Data
(60) Provisional application No. 61/110,464, filed on Oct. 31, 2008.

(51) Int. Cl. B41J 29/393

(52) U.S. Cl. 347/19

(57) ABSTRACT

A method of detecting the properties of a printing target in a printing apparatus capable of performing a recording process on the printing target. The method uses a vertical cavity surface emitting laser disposed in the printing apparatus and comprises transporting the printing target through the printing apparatus, emitting a wavelength modulated optical signal toward the printing target using the vertical cavity surface emitting laser, receiving a reflection of the wavelength modulated optical signal, and analyzing the reflected optical signal to identify a property of the printing target.

### CROSS-REFERENCE TO RELATED APPLICATIONS

This application claims the benefit of U.S. Provisional Application Ser. No. 61/110,464, filed Oct. 31, 2008, entitled “USE OF VCSEL TO DETECT PAPER IN A PRINTER,” which application is incorporated by reference in its entirety.

### BACKGROUND OF THE INVENTION

1. The Field of the Invention

The present invention relates to a semiconductor laser. More specifically, the present invention relates to a vertical cavity surface emitting laser (VCSEL) for use in a printer.

2. The Relevant Technology

As people have become increasingly dependent on electronics and computers for performing their day-to-day tasks, the need to accurately and quickly produce a permanent or hard copy of the information stored in electronic form has increased. One method of converting electronic information into a hard copy is by using a printer or other recording medium. As advancements have been made in computers and related electronic devices, corresponding advancements have been required in printers. For example, as digital cameras have been developed with increasingly high resolution, there has been an increased need for a printer which is capable of printing at a correspondingly high resolution. Thus, there is an increased need for a more accurate printer.

One reason why the accuracy of a printing operation is currently limited is due to difficulties in accurately detecting the location or speed of the paper or other printing medium. Currently, light-emitting diodes or LEDs are used to detect the location or speed of the printing medium as it is transported through the printer. One problem with using LEDs to detect the paper, however, is that LEDs typically have difficulties detecting the edge of a paper when a printing operation requires more than one piece of paper and consecutive pages are fed through the printer. Similarly, printers equipped with LED detection systems often have difficulties detecting the properties of transparent printing mediums.

In some instances, the inability to accurately detect the traveling speed or edge of a printing medium may result in errors or wasted ink. For instance, when a photo is being printed, it is important to accurately detect the location of the edge of the photo paper so that the amount of overspray or ink ejected to the area beyond the edge of the printing medium may be reduced. Thus, there is a need for a printer with an improved detection system that is capable of improving print quality and efficiency.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to systems and methods for detecting paper in printers using a vertical cavity surface emitting laser (VCSEL) or other laser including edge emitters.

One aspect of the invention is a printing apparatus capable of detecting the properties of a printing target which uses a vertical cavity surface emitting laser disposed in the printing apparatus. A method comprises transporting the printing target through the printing apparatus, emitting a wavelength modulated optical signal toward the printing target using the vertical cavity surface emitting laser, receiving a reflection of the wavelength modulated optical signal, and analyzing the reflected optical signal to identify a property of the printing target.

Another aspect of the invention is a printing apparatus capable of detecting the properties of a printing target. The printing apparatus comprises a transport system capable of transporting the printing target through the printing apparatus, a vertical cavity surface emitting laser capable of emitting a wavelength modulated optical signal onto the printing target, a detector capable of receiving a reflection of the wavelength modulated optical signal and converting the received reflected signal into an electrical signal, and an analyzing unit capable of analyzing the electrical signal to identify a property of the printing target.

Another aspect of the invention is a method of locating an edge of a printing target in a printing apparatus capable of performing a recording process on the printing target. The method comprises emitting a wavelength modulated optical signal towards a first surface within the printing apparatus using a vertical cavity surface emitting laser disposed in the printing apparatus, receiving a first reflection of the wavelength modulated optical signal when the wavelength modulated optical signal emitted toward the first surface is reflected from the first surface within the printing apparatus, transporting the printing target through the printing apparatus such that a portion of the printing target covers the first surface within the printing apparatus, receiving a second reflection of the wavelength modulated optical signal when the wavelength modulated optical signal emitted toward the first surface is reflected from a surface of the printing target, analyzing the first and second reflected optical signals to identify difference(s) between the first reflection and the second reflection, and determining the location of the edge of the printing target when a difference is identified between the first reflection and the second reflection.

As described more fully below, one advantage of the system described herein is the ability to more accurately detect the properties of a printing target (such as paper or other media) then in systems currently known in the art. More specifically, by using a light source capable of generating a more intense signal in a smaller area, the systems described herein are able to detect smaller variations in the reflected signal, and hence are capable of more accurately determining the properties of the printing target.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a printing apparatus capable of performing aspects of the invention;

FIG. 2 is a cross-sectional view of a printing head which is capable of detecting properties of the paper using a VCSEL;

FIG. 3 illustrates a self-mixing VCSEL that may be used in association with an alternate embodiment;

FIG. 4 is a block diagram illustrating a method of detecting properties of paper in a printer using a VCSEL;

FIG. 5 is a graph of a laser signal generated and captured according to a VCSEL used in association with embodiments of the present invention;

FIG. 6A is a graph of a laser signal generated and captured by a LED-system currently known in the art; and

FIG. 6B is a graph of a laser signal generated and captured according to a VCSEL used in association with embodiments of the present invention.

### DETAILED DESCRIPTION OF THE PREFERRED EMBODIMENTS

Embodiments of the invention relate to printing apparatuses and to methods for a printing apparatus to detect a property of a printing target such as paper. More specifically, embodiments of the invention relate to systems and techniques for measuring and detecting the properties of a paper or other printing medium as it is transported through a printer. Embodiments of the invention utilize vertical cavity surface emitting lasers (VCSELs), which are a type of light source that are typically used in communication systems. VCSELS are popular in the communication industry in part because they can be manufactured in large quantities, due to their relatively small size. Another advantage of VCSELS is that they can be manufactured relatively efficiently due to their ability to be tested while still in wafer form.

### I. Printing Apparatus

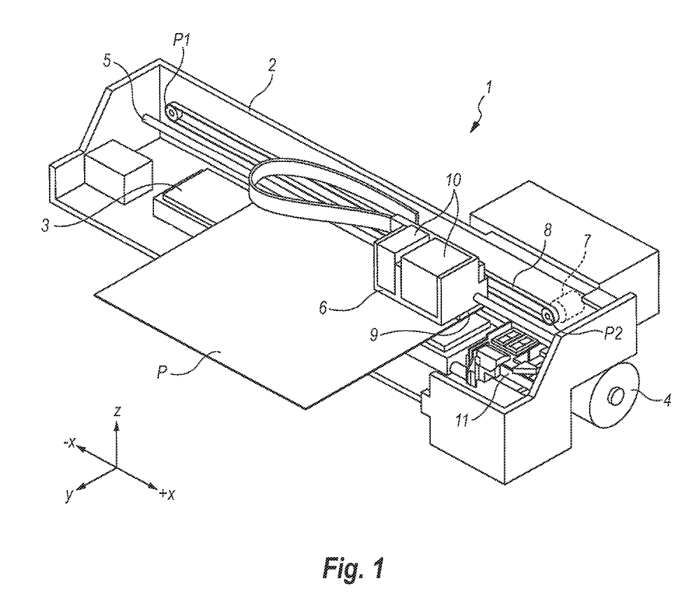

FIG. 1 illustrates a printer capable of being used in association with the present invention. Although the invention is described with reference to a printer, the invention may be embodied in a variety of printing or recording apparatuses and is not limited to specific embodiment described herein. Embodiments of the invention can be used in ink jet printers, thermal printers, desktop printers, large format printers, and/or other printing or recording apparatuses. As shown in FIG. 1, the printer 1 includes a frame 2 having a substantially rectangular parallelepiped shape. In the frame 2, a platen 3 is provided in the longitudinal direction (X-direction), which is also referred to as the main scanning direction. A printing target, in this case a piece of paper P, is fed onto a platen 3 by a paper feeding mechanism, which includes a paper feed motor 4. The paper P is fed in a paper feeding direction, which is shown in FIG. 1 as the Y-direction.

In the frame 2, a guide member 5 is provided to be parallel with the platen 3. A carriage 6 is inserted in the frame 2 and is supported by the guide member 5 so as to move along the guide member 5. In addition, a carriage motor 7 is attached to the frame 2. The carriage 6 is in drivable connection with the carriage motor 7 via a timing belt 8, which is stretched between a pair of pulleys P1 and P2. When the carriage motor 7 is driven, its driving force is transferred to the carriage 6 through the timing belt 8. The carriage 6 receives the driving force and is guided by the guide member 5 to reciprocate in a main scanning direction (+x direction and −x direction) in parallel with the platen 3. One of skill in the art can appreciate that the mechanisms for moving a carriage or a printing head can vary depending on the specific printer. In some instances, it may be the media that is moved relative to a print head.

As shown in FIG. 1, a recording head 9 is provided on a lower surface of the carriage 6. The recording head 9 serves as a printing head which prints an image onto the paper P (or other media or surface). The recording head 9 has a planar nozzle forming surface in this example, although one of skill in the art can appreciate a variety of different recording heads 9 that use various configurations to print. In the nozzle forming surface, a plurality of nozzles may be formed to face the recording paper P. In one embodiment, the printer 1 also includes a VCSEL which is capable of detecting properties of the recording paper P as described more fully below. Examples of properties that the VCSEL may detect as the VCSEL detects the surface of the recording paper include the speed that the paper is being transported through the printer 1 by the paper feeding mechanism, as well as the precise location of the edges of the recording paper P.

As shown in FIG. 1, an ink cartridge 10 serving as a liquid storage unit is detachably mounted in the carriage 6. The ink cartridge 10 may be divided into a plurality of storage chambers, and in each of the storage chambers, ink serving as a liquid (for example, pigment ink and reactive ink) is stored. That is, the printer 1 of FIG. 1 is called on-carriage type of printer. Ink stored in the ink cartridge 10 is supplied to the corresponding nozzle of the recording head 9. With this configuration, when the ink cartridge 10 is mounted in the carriage 6, ink stored in the ink cartridge 10 flows into the recording head 9. Then, ink flowing into the recording head 9 is pressurized by a piezoelectric element and ejected from the nozzle openings of the nozzles toward the recording paper P in the form of ink droplets.

In the printer 1, the region where ink droplets are discharged onto the recording paper P while the carriage 6 reciprocates is referred to as a printing region or ejecting region. In addition to the printing region, the printer 1 also includes a non-printing region where the nozzles are capped when the printer is not performing a printing operation. A maintenance unit 11 is provided in the non-printing region. The maintenance unit 11 periodically performs maintenance operations on the recording head 9 in order to ensure that the nozzles are able to properly discharge the liquid during the printing process.

In this embodiment, the printer 1 is capable of performing edgeless printing, wherein the carriage 6 is capable of traveling to the area beyond the edge of the paper P so that nozzles 9 of the recording head 9 may eject ink onto the entire area of the paper P without leaving a margin on the edges of the paper P without a printed image. As previously mentioned, one problem with printers currently known in the art is that it is difficult to perform edgeless printing without overspraying the ink beyond the edge of the paper and onto the platen 3 because it is often difficult to locate the exact location of the edge of the paper. Unfortunately, this overspray can result in ink transfer from one printing process to a subsequent process as the ink sprayed onto the platen 3 is transferred onto a subsequent piece of paper. Moreover, the overspray can result in smeared images and wasted ink.

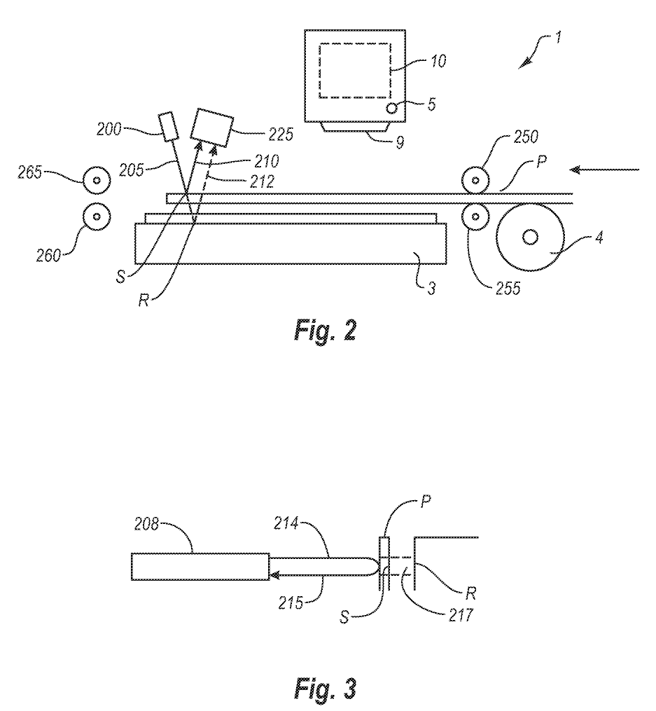

FIG. 2 is a cross sectional view illustrating one embodiment of a printer 1 which uses a VCSEL 200 to detect properties of the target paper P as it travels through the printer 1. In this example, the VCSEL 200 is disposed in the printer 1 in an area adjacent to the path of the recording head 9 as it is moved in the scanning direction in order to reliably detect properties of the paper P as it travels through the printer 1. In the embodiment shown in FIG. 2, a plurality of rollers 4 and 250-265 are used to transport the paper P through the printer 1. The rollers 4 and 250-265 are driven by a plurality of motors that operate in response to a series of signals sent by a controller. In this embodiment, the configuration includes a feeding roller 4 and transportation rollers 250, 255, 260, and 265.

In this example, the VCSEL 200 is a laser which emits a signal 205 towards a target . In this case, the target area R is on the surface of the platen 3 opposite to the emitting surface of the VCSEL 200. When a piece of paper P is traveling through the printer 1 and a portion of the piece of paper S is located between the emitting surface of the VCSEL 200 and the surface of the platen 3, the portion of paper S will act as a target area. When the paper is located between the emitting surface of the VCSEL 200 and the target area R, the light 205 emitted from the VCSEL 200 will be reflected from the portion of paper S as a reflected signal 210. The reflected signal 210 is then captured by a signal detector 225.

In other instances, when there is no paper P traveling through the printer 1, or when the edges of two subsequent sheets of paper P form a space therebetween, which space is located above the target area R, the light emitted 205 from the surface of the VCSEL 200 will reflect off the surface of the platen 3. When the paper P is not located between the VSCEL 200 and the target area R, the signal 205 emitted from the VCSEL 200 is reflected from the target area R. The reflected signal 212 (shown in FIG. 2 as a dotted line) is then captured by the detector 225. The captured signals are then analyzed in a process described more fully below. Using this process, various characteristics of the paper may be determined.

As described more fully below, using the difference between the two reflected signals 210, 212, it is possible to accurately detect where the edge of the paper P is located.

As may be understood by one of ordinary skill in the art, the VCSEL 200 may be located any number of places within the printer 1 and/or at various orientations within the printer 1. For example, the paper P may be fed horizontally (shown in FIG. 2), vertically, or at an angle, and the VCSEL 200/signal detector 225 may be positioned in whatever orientation is necessary in order to emit the laser 205 and receive the reflected signal 210, 212. Moreover, the printer 1 may utilize a number of VCSELs and detectors in order to detect properties of the paper P in a variety of locations. For example, a variety of VCSELs and detectors may be disposed at different locations in the printer P in order to detect a paper feeding malfunction, misalignment, or paper jam, by calculating where the paper P is located, and whether or not the paper P is moving at the various detectors. Furthermore, one or more VCSELs may be disposed on the recording head 9 within the printer 1.

### II. Vertical Cavity Surface Emitting Laser (VCSEL)

The structure and characteristics of the VCSEL will now be described. One benefit of using a VCSEL in the printer 1 is that VCSELs are capable of creating a powerful circular beam of light in a small area, which increases the laser's ability to detect minor changes in the surface of the printing medium. This provides various advantages over the configurations currently known in the art. For example, the method and system described herein is capable of detecting the edge of the printing medium, so that overspray may be minimized.

As previously mentioned, embodiments of the invention utilize a VCSEL in a detection system. At a basic level, semiconductor lasers are essentially p-n-junctions that convert electrical energy into light energy. Typically, a gain medium or active region is formed at the p-n-junction between the p-type material and the n-type material. Often the active region includes a gain medium such as quantum wells. As light passes through the active region or gain medium, the light is amplified by stimulated emissions. At certain frequencies or wavelengths, the semiconductor lasers lase and generate output light.

In VCSELs, minors are usually formed both above and below the active region. The mirrors reflect light back and forth through the active region. Within the VCSEL cavity that is effectively bounded by the minors or by this mirror system, the light resonates vertically or perpendicularly to the p-n-junction and some light emerges from a surface of the VCSEL. Because the light is resonating vertically, the cavity length of a VCSEL is often very short with respect to the direction of light travel and the length of the cavity thus has an effect on the ability of a proton to produce additional photons through stimulated emission, particularly at low carrier densities. The minors increase the likelihood of a photon stimulating the emission of an additional photon. As previously mentioned, the light emitted by VCSELs typically has multiple transverse modes or wavelengths.

As shown in FIG. 2, the VCSEL 200 may be used to emit a pulse which may be received by a photodiode detector 225 or other signal acquisition device formed in a separate structure from the VCSEL 200 which serves as a light-receiving device which converts the interference light between the laser beam 205 emitted from the VSCEL 200 into an electrical signal. In other embodiments, such as the embodiment shown in FIG. 3, the VCSEL 200 may be integrated as a VCSEL-Photodiode chip 208, which may include a VCSEL and a photodiode detector formed from a common epitaxial structure.

In the integrated VCSEL-Photodiode chip 208 shown in FIG. 3, light is emitted 214 from the VCSEL-Photodiode chip 208, reflected against either target R or a portion of paper P, and received as a reflected signal 217 or 215, respectively. Furthermore, the VCSEL Photo-diode chip 208 may be self-mixing. As may be understood by one of ordinary skill in the art, a self-mixing VCSEL 208 is a VCSEL wherein a fraction of the light 215 directed towards a target is reflected or scattered by the target back towards the VCSEL. This reflected light may be allowed to re-enter the laser cavity, creating a modulation in both the amplitude and frequency of the lasing field. As described more fully below, this modulation can be used to detect the properties of the surface reflecting the light.

In this embodiment, the VCSEL-Photodiode chip 208 may determine the characteristics of the paper P by calculating the period of time between the time when the signal is emitted and the time when the reflected signal 215 or 217 is received. Because the signal reflected from the target R travels a greater distance than the signal reflected from the paper P disposed above the target R, the signal reflected from the target R will take a greater period of time to be reflected than the signal reflected from the area S of the paper P.

In either configuration described herein, the captured signal is analyzed in order to detect the properties of the target that reflects the light. For example, in addition to using the delay between the time when the signal is emitted to the time when the reflected signal is received, the frequency and amplitude of the reflected light may be analyzed in order to determine the speed that the target surface is moving. Moreover, the reflected light may be used to detect the presence or absence of a printing medium.

In some embodiments, the VCSEL 200 or 208 may generate an infrared light. One advantage of using an infrared light is that infrared light is agnostic to all colors of ink except for black. Thus, the light reflected by a paper or other printing medium P would be unchanged for a printing medium P which has a variety of images printed on its surface, including yellow, magenta, and cyan. Thus, the system would be capable of detecting properties of the paper, regardless of whether or not there is an image printed on its surface.

In other situations, the infrared beam's ability to recognize black ink would enable the detection system of the printer 1 to more accurately align the paper for more accurate printing. For example, a series of small black demarcations could be printed on the printing medium, in order to act as a series of guides for more accurately placing the printing images. In some embodiments, these demarcations may even be imperceptible to the human eye. Using the detection system described more fully below, the system may accurately determine the position of the printing head 6 in relation to the printing medium P. In other embodiments, the black demarcations may be covered by recording an image over the demarcations.

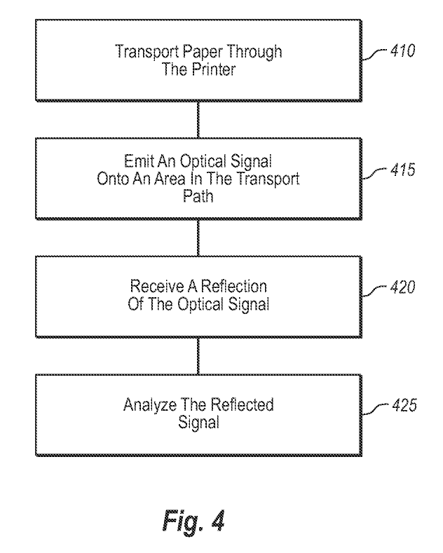

FIG. 4 is a block diagram that illustrates a method of using a VCSEL 200 (or VCSEL 208) to detect the motion, speed, and/or other properties of paper P as it passes through the printer 1. As previously described, the method begins as the paper P is transported 410 through the printer 1. As the paper P is transported through the printer 1, an optical signal (e.g., optical signal 205 or 214) is emitted 415 towards an area R in the transport path of the paper. The reflection of the emitted optical signal is received 420 by the system and analyzed 425.

As previously described, the optical signal 205 or 214 is emitted toward a surface R within the printer 1. When the paper P is not in the path of the optical signal 205, the signal is continuously reflected from the surface R, resulting in a relatively constant signal 212 or 217 being received by the system. However, as the paper P gradually moves along the transport path in the printer 1, a portion of the paper S eventually enters the area where the VCSEL 200 is emitting the optical signal 205. Because the portion of the paper S covers the surface R where the signal 205 is directed, the signal 205 or 214 is reflected from the portion of paper S instead of the surface R. Then, the signal reflected 210 or 215 from the piece of paper S is captured and analyzed 425 in order to identify the properties of the paper P.

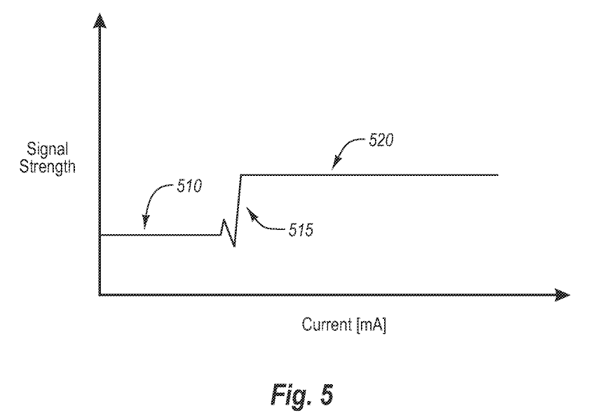

In one embodiment, the system may be used to detect the presence or absence of paper P in the transport path. Because the paper P has different reflective properties than the surface R within the printer 1, the reflected signal 210 or 215 captured by the system when the signal is reflected from the paper P will differ from the reflected signal 212 or 217 that occurs when there is no paper in the path of the signal. For example, FIG. 5 illustrates an exemplary signal that may be captured and analyzed by the system of the invention. As shown in FIG. 5, the signal has a level, constant signal 510 during the period of time before the paper P reaches the location of the target area R in the transport path. Then, when the edge of the paper P enters the target area R, the signal begins to be reflected off the surface of the paper P and the signal changes 515. Then as the width of the paper P travels across the target area, the signal 520 may again be constant.

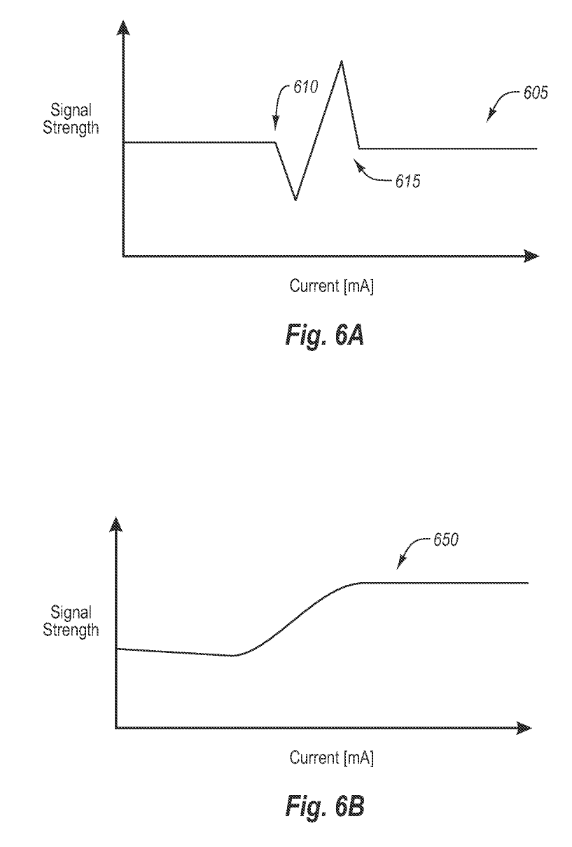

As previously described, one advantage of the system described herein is the ability to more accurately detect the properties of the paper than in systems currently known in the art. For example, FIGS. 6A and 6B illustrate exemplary signals that may be captured and analyzed. FIG. 6A illustrates a system which includes a VCSEL, such as those previously described herein. One advantage of a configuration which uses a VCSEL as a detection mechanism is that it creates a more powerful beam of light which is more sensitive to small signal changes than the light emitting units of conventional systems. For instance, in the exemplary signal 605 shown in FIG. 6A, the signal 605 illustrates a signal that corresponds to the transition between two subsequent sheets of paper. By analyzing the signal, the edges 610 and 615 may be identified.

FIG. 6B illustrates a signal 650 corresponding to the transition between two subsequent sheets of paper that may be captured when the light emitting source is an LED or other source currently used in the art. As shown in FIG. 6B, the signal is not as sensitive, meaning that it may be more difficult to identify the precise location of the transition regions in the resulting signal captured by the system. One advantage of the systems of the invention is the ability to more accurately locate the edge of the paper, which may be particularly useful in edgeless printing systems.

As previously described, the captured signal is analyzed to detect properties of the paper moving through the printer. As may be understood by one of ordinary skill in the art, the analysis may include identifying changes in the signal, including a change in noise, or analyzing the strength, frequency, or other properties of the captured signal in order to determine other properties of the paper. For example, the detected signal may have variations that are due to the light emitted from the laser impinging on demarcations on the paper or other medium. These demarcations can thus be used to quickly identify a paper jam, paper speed and paper position. The demarcations themselves may be configured to generate specific changes in the laser light such that certain conditions can be detected. For example, one demarcation can be used to identify the closeness of an edge of paper. The demarcations, or the paper alone in some instances, can be used to determine paper speed or printing speed while printing on a particular page.

In another embodiment, the location of the edge of the paper may be precisely located. In some instances, a particular type of paper may be identified to set printer settings, for instance, the reflection may be different on different types of paper. The laser can be used in combination with characteristics of the paper itself (e.g., demarcations) to identify paper type, paper speed, paper motion, printer problems such as paper jams, and the like. In some instances, multiple lasers or a single VCSEL that can split and redirect a laser beam in different directions can be used can be used to determine paper alignment by detecting positions of adjacent sides of the paper.

In other embodiments, the signal may be analyzed to identify other properties of the paper, including the speed that the paper is traveling through the printer and the like. Embodiments may also be used to identify any paper jams or errors in the paper feeding process. Furthermore, and as may be understood by one of ordinary skill in the art, the system may output any number of various signals based on the analysis of the captured signal. For example, the system may output a digital signal, an analog voltage signal, a threshold signal, or a simple yes/no indication of whether the paper is present or is moving. This determination may also be output to a digital interface where a user may review the information.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a printing apparatus capable of performing a recording process on a printing target, a method of detecting the properties of the printing target using a vertical cavity surface emitting laser disposed in the printing apparatus, the method comprising:
transporting the printing target through the printing apparatus;
emitting a wavelength modulated optical signal toward the printing target using the vertical cavity surface emitting laser;
receiving a reflection of the wavelength modulated optical signal; and
analyzing the reflected optical signal to identify a property of the printing target.

2. The method of claim 1, wherein analyzing the reflected optical signal comprises identifying a change in the reflected optical signal to identify an edge of the printing target.

3. The method of claim 1, wherein analyzing the reflected optical signal comprises identifying a change in the reflected optical signal to identify a speed of the printing target.

4. The method of claim 1, wherein the wavelength modulated optical signal emitted to the printing target is an infrared signal.

5. The method of claim 1, wherein the reflection of the wavelength modulated optical signal is received by a photodiode detector.

6. The method of claim 1, wherein the vertical cavity surface emitting laser is a self-mixing vertical cavity surface emitting laser.

7. The method of claim 1, wherein analyzing the reflected optical signal comprises converting the reflected optical signal into an electronic signal and analyzing the electronic signal.

8. The method of claim 7, wherein the electronic signal is analyzed to identify changes in an amplitude, voltage, or noise of the electronic signal.

9. The method of claim 1, wherein analyzing the reflected optical signal comprises identifying a change in the reflected optical signal and the method further comprises outputting a signal based on the identified change in the reflected optical signal.

10. A printing apparatus capable of detecting the properties of a printing target, the printing apparatus comprising:
a transport system capable of transporting the printing target through the printing apparatus;
a vertical cavity surface emitting laser capable of emitting a wavelength modulated optical signal onto the printing target;
a detector capable of receiving a reflection of the wavelength modulated optical signal and converting the received reflected signal into an electrical signal; and
an analyzing unit capable of analyzing the electrical signal to identify a property of the printing target.

11. The system of claim 10, wherein the analyzing unit is capable of identifying an edge of the printing target.

12. The system of claim 10, wherein the analyzing unit is capable of identifying a speed of the printing target.

13. The system of claim 10, wherein the wavelength modulated optical signal is an infrared signal.

14. The system of claim 10, wherein the detector is a photodiode detector.

15. The system of claim 10, wherein the vertical cavity surface emitting laser is a self-mixing vertical cavity surface emitting laser.

16. The system of claim 10, wherein the analyzing unit is capable of identifying changes in an amplitude, voltage, or noise of the electronic signal.

17. The system of claim 10, wherein the analyzing unit is further capable of outputting a detection signal based on the identified property of the printing target.

18. In a printing apparatus capable of performing a recording process on a printing target, a method of locating an edge of the printing target, the method comprising:
emitting a wavelength modulated optical signal towards a first surface within the printing apparatus using a vertical cavity surface emitting laser disposed in the printing apparatus;
receiving a first reflection of the wavelength modulated optical signal when the wavelength modulated optical signal emitted toward the first surface is reflected from the first surface within the printing apparatus;
transporting the printing target through the printing apparatus such that a portion of the printing target covers the first surface within the printing apparatus;
receiving a second reflection of the wavelength modulated optical signal when the wavelength modulated optical signal emitted toward the first surface is reflected from a surface of the printing target;
analyzing the first and second reflected optical signals to identify whether a difference exists between a signal level of the first reflection and the second reflection; and
determining a location of the edge of the printing target when a difference in signal level is identified between the first reflection and the second reflection.

19. The method of claim 18, wherein the wavelength modulated optical signal is an infrared signal.

20. The method of claim 18, wherein the first and second reflections of the wavelength modulated optical signal is received by a photodiode detector.
